(19) United States
(12) Patent Application Publication
(10) Pub. No.: US 2026/0301376 A1
(43) Pub. Date: Oct. 1, 2026

(54) FEATURE POINT EXTRACTION METHOD, FEATURE POINT EXTRACTION SYSTEM, AND NON-TRANSITORY COMPUTER-READABLE STORAGE MEDIUM STORING PROGRAM

(71) Applicant: SEIKO EPSON CORPORATION, Tokyo (JP)

(72) Inventors: Akihiro NAKASHIMA, Beppu-shi (JP); Masaki MIZOMORI, Oita-shi (JP)

(21) Appl. No.: 19/630,571

(22) Filed: Mar. 27, 2026

(30) Foreign Application Priority Data
Mar. 28, 2025 (JP) 2025-056584

(51) Int. Cl. G06V 10/77; G06N 3/045; G06V 10/82

(52) U.S. Cl. CPC G06V 10/7715; G06N 3/045; G06V 10/82

(57) ABSTRACT

A feature point extraction method includes: inputting first input data including a first picked-up image formed by picking up an image of a first area including a screen and four corners of the screen, to a first learning model that, when input data including a picked-up image formed by picking up an image of an area including a projection target and four corners of the projection target is input thereto, outputs output data representing four feature points corresponding one-to-one to the four corners in the picked-up image; and acquiring first output data representing four feature points output from the first learning model.

The present application is based on, and claims priority from JP Application Serial Number 2025-056584, filed Mar. 28, 2025, the disclosure of which is hereby incorporated by reference herein in its entirety.

### BACKGROUND

### 1. Technical Field

The present disclosure relates to a feature point extraction method, a feature point extraction system, and a non-transitory computer-readable storage medium storing a program.

### 2. Related Art

A program having an installation maintaining function of maintaining the position and shape of a projection image projected from a projector onto a projection target for a long period of time is known. For example, JP-A-2024-99941 discloses a program that extracts some candidates of feature points necessary for generating a projective transformation matrix used for correction of a projection image and causes a user to select a feature point from the extracted candidates of feature points.

JP-A-2024-99941 is an example of the related art.

However, with the technique according to JP-A-2024-99941, in order to select one feature point corresponding to a corner of a screen from the extracted candidates of feature points, the user needs to examine the feature point and therefore the user finds it troublesome.

### SUMMARY

According to an aspect of the present disclosure, a feature point extraction method includes: inputting first input data including a first picked-up image formed by picking up an image of a first area including a first projection target and at least one first corner of the first projection target, to a trained model that, when input data including a picked-up image formed by picking up an image of an area including a projection target onto which an image from a projection device is projected and at least one corner of the projection target is input thereto, outputs output data representing at least one feature point corresponding one-to-one to the at least one corner in the picked-up image; and acquiring first output data representing at least one first feature point corresponding one-to-one to the at least one first corner output from the trained model.

According to another aspect of the present disclosure, a feature point extraction system includes: an external device having a trained model that, when input data including a picked-up image formed by an image pickup device picking up an image of an area including a projection target onto which an image from a projection device is projected and at least one corner of the projection target is input thereto, outputs output data representing at least one feature point corresponding to the at least one corner in the picked-up image; a first projection device that projects a first projection image onto a first projection target; and a first image pickup device that picks up an image of a first area including the first projection image, the first projection target, and at least one first corner of the first projection target, and the first image pickup device transmits first input data including a first picked-up image formed by picking up an image of the first area, to the external device, and the external device inputs the first input data to the trained model, acquires first output data representing at least one first feature point corresponding to the at least one first corner output from the trained model, and transmits the first output data to the first projection device.

According to still another aspect of the present disclosure, a non-transitory computer-readable storage medium storing a program is provided, and the program causes a computer to execute: inputting first input data representing a first picked-up image including a first projection target and at least one first corner of the first projection target, to a trained model that, when input data including picked-up image information representing a picked-up image formed by picking up an image of an area including a projection target onto which an image from a projection device is projected and at least one corner of the projection target is input thereto, outputs output data representing at least one feature point corresponding to the at least one corner in the picked-up image; and acquiring first output data representing at least one first feature point corresponding to the at least one first corner output from the trained model.

### BRIEF DESCRIPTION OF THE DRAWINGS

FIG. 1 shows the configuration of an image display system according to a first embodiment.

FIG. 2 is a schematic diagram showing how a first projection image is displayed in a first period.

FIG. 3 is a block diagram showing the configuration of a projector shown in FIG. 1.

FIG. 4 is a block diagram showing the configuration of a storage device of the projector shown in FIG. 1.

FIG. 5 is a schematic diagram showing how a third projection image is displayed.

FIG. 6 is a schematic diagram showing how a fourth projection image is displayed.

FIG. 7 is a schematic diagram showing how a fifth projection image is displayed.

FIG. 8 is a schematic diagram showing how a sixth projection image is displayed.

FIG. 9 is a schematic diagram showing how a second projection image is displayed.

FIG. 10 is a block diagram showing the configuration of a server shown in FIG. 1.

FIG. 11 is a flowchart showing operations of a processing device shown in FIG. 3 and a processing device shown in FIG. 10.

FIG. 12 is a flowchart showing an example of the operation of a subroutine shown in FIG. 11.

FIG. 13 is a flowchart showing an example of the operation according to Modification Example 8.

### DESCRIPTION OF EMBODIMENTS

A preferred embodiment according to the present disclosure will be described below with reference to the accompanying drawings. In the drawings, the dimensions and scales of the respective parts are different from the actual ones as appropriate, and some parts are schematically shown in order to facilitate understanding. The scope of the present disclosure is not limited to the embodiment unless the description given below includes any description to the effect that the present disclosure is limited.

### 1. First Embodiment

### 1.1. Overview of Image Display System

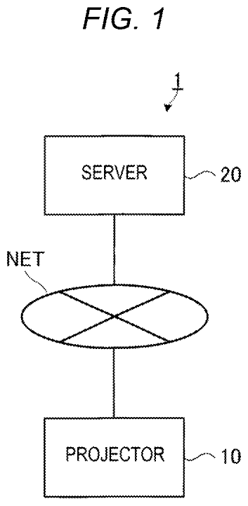

An overview of an image display system 1 according to a first embodiment will be described below with reference to FIGS. 1 to 12. The image display system is an example of a feature point extraction system.

FIG. 1 shows the configuration of the image display system 1 according to the first embodiment. The image display system 1 includes a projector 10, a server 20, and a network NET.

The network NET includes one or both of a wired network and a wireless network. The network NET is an electric communication line including the internet, an intranet, and the like. In the image display system 1, the projector 10 and the server 20 are communicably connected to each other via the network NET.

The projector 10 projects projection light onto a projection surface and thus displays a projection image on the projection surface. The projector 10 has a function of correcting the shape, brightness, color tone, and the like of the projection image, using a picked-up image formed by picking up an image of the displayed projection image.

The server 20 has a function of acquiring a picked-up image picked up by the projector 10, from the projector 10, and extracting a feature point for correcting the shape of the projection image, based on the acquired picked-up image. The server 20 has a function of transmitting feature point information regarding the extracted feature point to the projector 10.

Therefore, the image display system 1 is a system in which the server 20 extracts a feature point for correcting the shape of the projection image projected by the projector 10 and corrects the shape of the projection image, based on the extracted feature point. In the present specification, the processing of extracting a feature point, which is a process before the shape of the projection image is corrected, will be described.

### 1.2. Overview of Projector

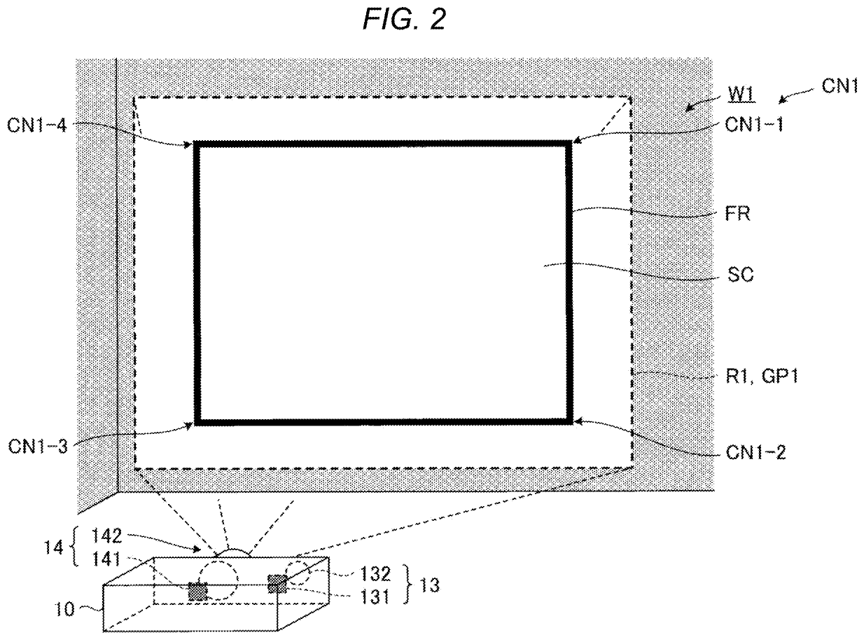

FIG. 2 is a schematic diagram showing how a first projection image GP1 is displayed in a first period.

The projector 10 projects projection light in a first area R1 including a screen SC, which is a projection surface, and thus displays the first projection image GP1. The first projection image GP1 is an all-white image. The all-white image is an example of a white image. The first area R1 is broader than an area surrounded by a frame FR of the screen SC and covers the entire screen SC. The first period is a period including a time point at which the user starts an installation function of the projector 10 and the extraction of feature points corresponding to the four corners CN1-1 to CN1-4 of the frame FR of the screen SC is started. In the all-white image, the tone of each color of R, G, B is set to the maximum. The tone of the all-white image may not be necessarily the maximum. The first projection image GP1 is not limited to an all-white image and may be an image of another color. The first projection image GP1 is not limited to a monochromatic image and may be an image containing a plurality of colors.

The projector 10 includes an image pickup device 13 that picks up an image over a range including a predetermined area on the projection surface, and a projection device 14 that projects projection light onto the projection surface. The image pickup device 13 includes an image pickup lens 132 for condensing light, and an image pickup element 131 that converts the light condensed by the image pickup lens 132 into an electric signal and thus generates a picked-up image. The image pickup element 131 includes a plurality of pixels. The projection device 14 includes a light source, not illustrated, a light modulator 141 that modulates light emitted from the light source into projection light for displaying a projection image on the projection surface, and a projection lens 142 that projects the projection light modulated by the light modulator 141 onto the projection surface. The light modulator 141 includes a plurality of pixels. The projector 10 controls the projection device 14 and thus displays a projection image on the projection surface. In the present embodiment, the projector 10 controls the projection device 14 and thus displays a projection image on the screen SC.

### 1.3. Configuration of Projector

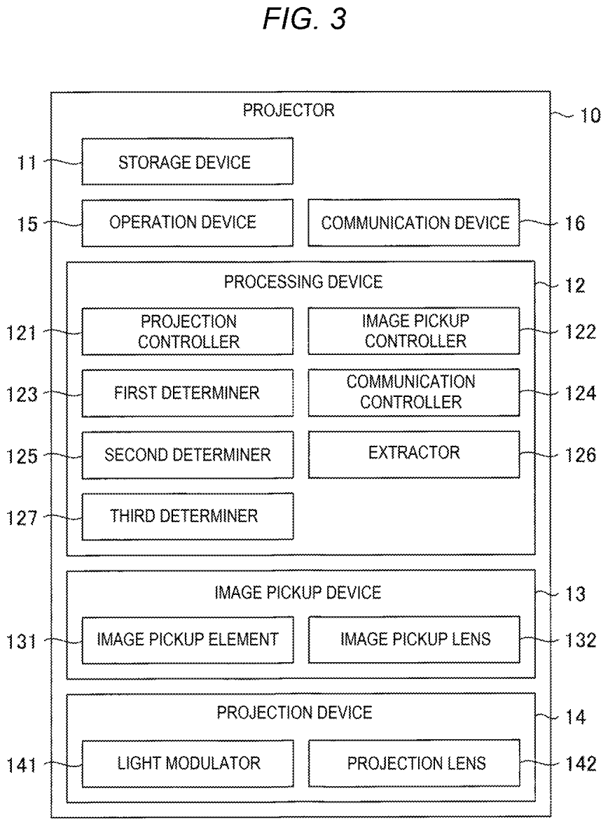

FIG. 3 is a block diagram illustrating the configuration of the projector 10 shown in FIG. 1. The projector 10 includes a storage device 11 that stores various information, a processing device 12 that controls the operation of the projector 10, the image pickup device 13, which picks up an image over a range including a predetermined area of the projection surface, the projection device 14, which projects projection light onto the projection surface, an operation device 15 that accepts an input operation from the user, and a communication device 16 that communicates with other devices. The elements provided in the projector 10 are coupled to one another via a single bus or a plurality of buses for communicating information. The image pickup device 13 is an example of a first image pickup device, and the projection device 14 is an example of a first projection device.

The processing device 12 has functions as a projection controller 121, an image pickup controller 122, a first determiner 123, a communication controller 124, a second determiner 125, an extractor 126, and a third determiner 127. As described above, the image pickup device 13 includes the image pickup element 131 and the image pickup lens 132. As described above, the projection device 14 includes the light source, not illustrated, the light modulator 141, and the projection lens 142.

The storage device 11 includes, for example, a volatile memory such as a RAM and a nonvolatile memory such as a ROM. RAM is an abbreviation for random-access memory. ROM is an abbreviation for read-only memory.

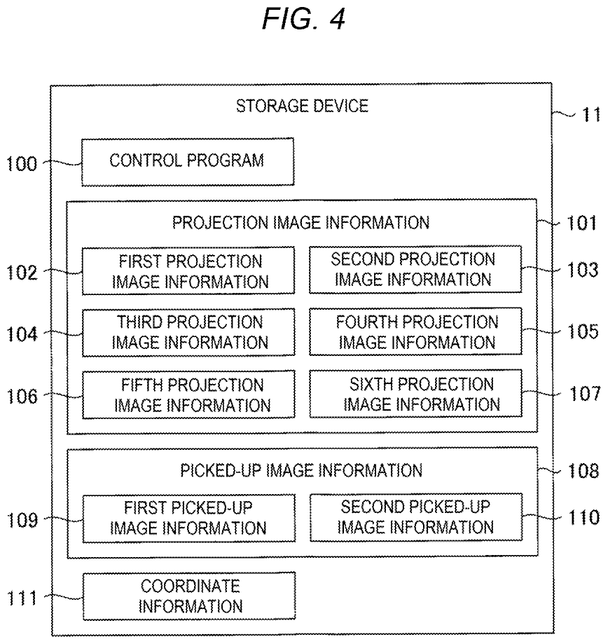

FIG. 4 is a block diagram showing the configuration of the storage device 11 of the projector 10 shown in FIG. 1. The nonvolatile memory provided in the storage device 11 stores a control program 100 that defines the operation of the projector 10, projection image information 101 representing an image to be projected onto the projection surface, picked-up image information 108 representing a result of picking up an image over a range including an area on the projection surface where the projection image is displayed, and coordinate information 111 representing coordinates of points contained in various images.

The projection image information 101 includes first projection image information 102 representing an image projected when a first projection image GP1 is displayed, second projection image information 103 representing an image projected when a second projection image GP2 is displayed, third projection image information 104 representing an image projected when a third projection image GP3 is displayed, fourth projection image information 105 representing an image projected when a fourth projection image GP4 is displayed, fifth projection image information 106 representing an image projected when a fifth projection image GP5 is displayed, and sixth projection image information 107 representing an image projected when a sixth projection image GP6 is displayed.

The picked-up image information 108 includes first picked-up image information 109 representing a first picked-up image GS1 and second picked-up image information 110 representing a second picked-up image GS2. The first picked-up image GS1 is an image picked up when the first projection image GP1 is projected. In other words, the first projection image GP1 is an image projected when the first picked-up image GS1 is picked up.

The coordinate information 111 is coordinate information indicating the coordinates of feature points to be extracted.

The volatile memory provided in the storage device 11 is used by the processing device 12 as a work area for executing the control program 100.

A part or the entirety of the storage device 11 may be provided in an external storage device, an external server, or the like. A part or all of the various information stored in the storage device 11 may be stored in the storage device 11 in advance, or may be acquired from an external storage device, an external server, or the like.

Referring again to FIG. 3, the processing device 12 includes one or a plurality of CPUs. However, the processing device 12 may include a programmable logic device such as an FPGA, or an ASIC, instead of the CPU or in addition to the CPU. CPU is an abbreviation for central processing unit, FPGA is an abbreviation for field-programmable gate array, and ASIC is an abbreviation for application-specific integrated circuit.

The processing device 12 reads the control program 100 from the storage device 11. The processing device 12 executes the read control program 100 and thus functions as the projection controller 121, the image pickup controller 122, the first determiner 123, the communication controller 124, the second determiner 125, the extractor 126, and the third determiner 127 shown in FIG. 3.

The projection controller 121 controls the projection device 14 to project projection light for displaying an image on the projection surface. Specifically, the projection controller 121 causes the projection device to project the projection light based on the projection image information 101 and thus display the projection image on the projection surface. In other words, the projection controller 121 causes the projection device to project the image represented by the projection image information 101 and thus display the projection image on the projection surface. The projection controller 121 controls the projection device 14 to display an image for assisting the user's operation on the projection surface.

In the present embodiment, the projection controller 121 controls the projection device 14 to project projection light for displaying an image on the screen SC as the projection surface.

Specifically, the projection controller 121 causes the projection device 14 to project the projection light based on the projection image information 101 and thus display the projection image on the screen SC. More specifically, the projection controller 121 causes the projection device 14 to project the projection light based on the first projection image information 102 and thus display the first projection image GP1 on the screen SC. The projection controller 121 also causes the projection device 14 to project the projection light based on the second projection image information 103 and thus display the second projection image GP2 on the screen SC.

The projection controller 121 also causes the projection device 14 to project the projection light based on the third projection image information 104 and thus display the third projection image GP3 on the screen SC. The projection controller 121 also causes the projection device 14 to project the projection light based on the fourth projection image information 105 and thus display the fourth projection image GP4 on the screen SC. The projection controller 121 also causes the projection device 14 to project the projection light based on the fifth projection image information 106 and thus display the fifth projection image GP5 on the screen SC. The projection controller 121 also causes the projection device 14 to project the projection light based on the sixth projection image information 107 and thus display the sixth projection image GP6 on the screen SC.

The image pickup controller 122 controls the image pickup device 13 to pick up an image over a range including an area on the projection surface where the projection image is displayed. The image pickup controller 122 acquires a picked-up image representing the result of the image pickup, from the image pickup device 13. The image pickup controller 122 stores, in the storage device 11, the picked-up image information 108 representing the acquired picked-up image.

In the present embodiment, the image pickup controller 122 controls the image pickup device 13 to pick up an image over a range including the first area R1 on the screen SC in which the first projection image GP1 is displayed. Also, the image pickup controller 122 acquires a picked-up image representing the result of the image pickup, from the image pickup device 13. Also, the image pickup controller 122 stores, in the storage device 11, the first picked-up image information 109 representing the acquired picked-up image.

The first determiner 123 determines whether the projector 10 is connected to the network NET. More specifically, the first determiner 123 determines that the projector 10 is the connected to the network NET (YES) when there is a response from a specific address on the internet by a ping (packet internet groper) command. Meanwhile, the processing device 12 determines that the projector 10 is not connected to the network NET (NO) when there is no response from a specific address on the internet by a ping command within a predetermined time.

When the projector 10 is connected to the network NET, the communication controller 124 transmits the first picked-up image GS1 to the server 20 via the communication device 16. The communication controller 124 transmits the second picked-up image GS2 to the server 20 via the communication device 16.

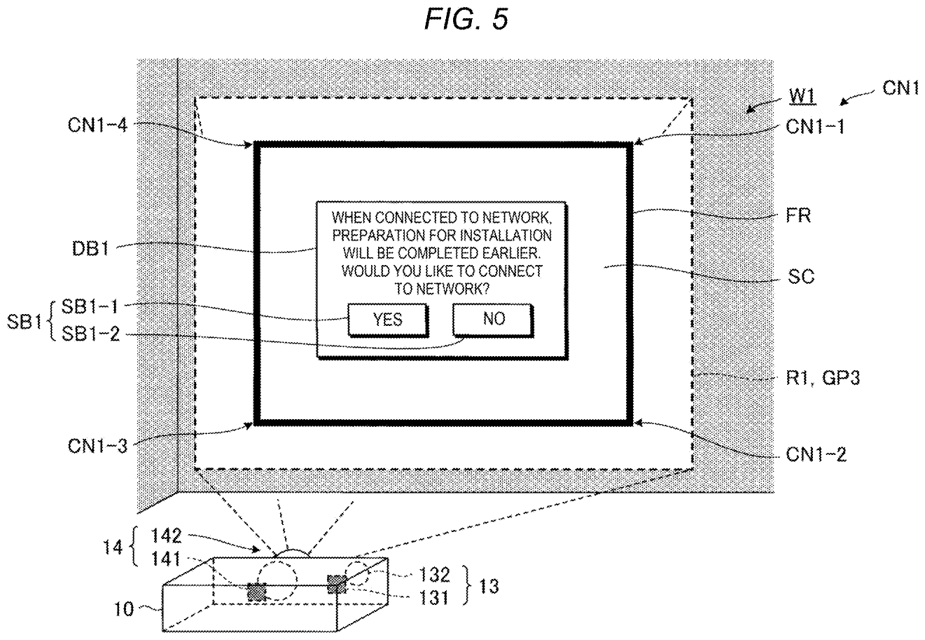

FIG. 5 is a schematic diagram showing how the third projection image GP3 is displayed. As shown in FIG. 5, the third projection image GP3 is an image in which a dialog box DB1 and a selection button SB1 are displayed on an all-white image. Therefore, the third projection image GP3 is an image in which the dialog box DB1 and the selection button SB1 are added to the first projection image GP1.

In the dialog box DB1, a message “When connected to the network, the preparation for installation will be completed earlier. Would you like to connect to the network?” and the selection button SB1 are displayed. The selection button SB1 includes a “Yes” button SB1-1 and a “No” button SB1-2. The user can select the “Yes” button SB1-1 or the “No” button SB1-2 by operating the operation device 15.

Referring to FIG. 3 again, when the projector 10 is not connected to the network NET, the second determiner 125 determines whether the user has connected the projector 10 to the network NET. More specifically, when the user selects the “Yes” button SB1-1 and the communication of a wired LAN or a wireless LAN is established, the second determiner 125 determines that the user has connected the projector 10 to the network NET (YES). Meanwhile, when the user selects the “No” button SB1-2, the processing device 12 determines that the user has not connected the projector 10 to the network NET (NO).

When the user selects not to connect the projector 10 to the network NET, the extractor 126 extracts feature points FP2-1 to FP2-4 corresponding to the four corners CN1-1 to CN1-4 of the screen SC. For the function related to the extraction of the feature points FP2-1 to FP2-4, a known image processing technique may be used. Examples of the known image processing techniques related to the detection of feature points include template matching, centroid detection, and an algorithm called “AKAZE (Accelerated KAZE)” or the like. In the present embodiment, “AKAZE” is used as the image processing technique. In the present specification, a detailed technical description of the “AKAZE” algorithm is omitted.

In the present embodiment, the extractor 126 performs first image processing on the image represented by the first picked-up image information 109 or the image represented by the second picked-up image information 110 and thus acquires the coordinate information 111 representing the coordinates of the four groups of feature points FP2-1 to FP2-4 corresponding one-to-one to the four corners disposed in the first picked-up image GS1 represented by the first picked-up image information 109 or the second picked-up image GS2 represented by the second picked-up image information 110. The extractor 126 stores the acquired coordinate information 111 in the storage device 11. The first image processing is image processing for detecting feature points.

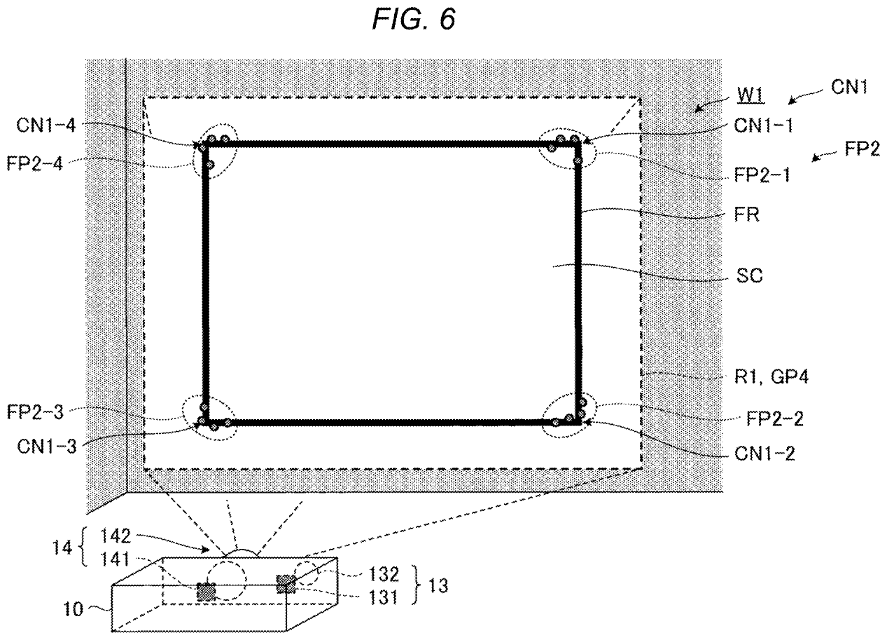

FIG. 6 is a schematic diagram showing how the fourth projection image GP4 is displayed. As illustrated in FIG. 6, the extractor 126 extracts a plurality of feature points for each of the four groups of feature points FP2-1 to FP2-4. In this case, the user needs to select one point to be adopted from the plurality of feature points.

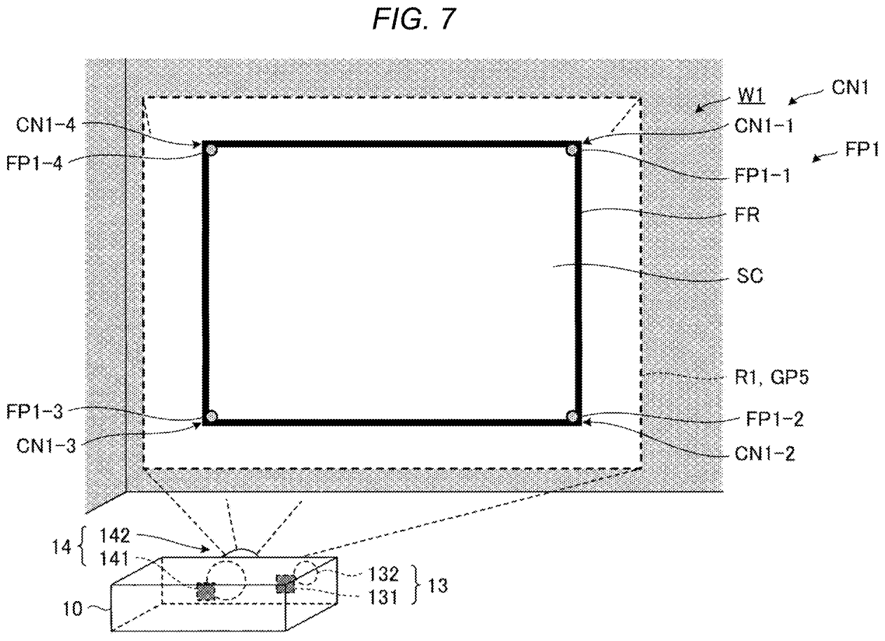

FIG. 7 is a schematic diagram showing how the fifth projection image GP5 is displayed. As shown in FIG. 7, the fifth projection image GP5 is an image in which four feature points FP1-1 to FP1-4 are displayed on an all-white image.

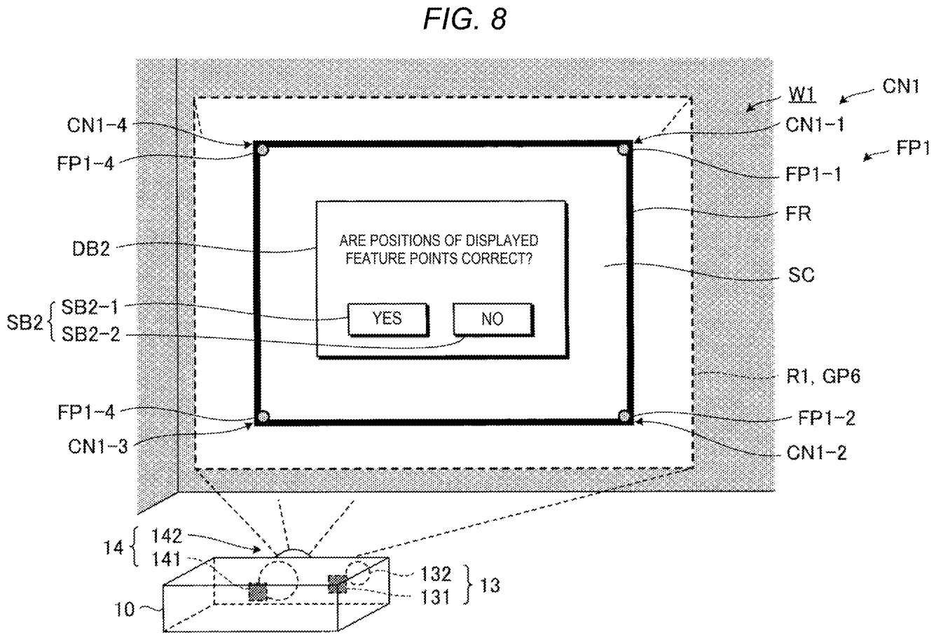

FIG. 8 is a schematic diagram showing how the sixth projection image GP6 is displayed. As shown in FIG. 8, the sixth projection image GP6 is an image in which four feature points FP1-1 to FP1-4, a dialog box DB2, and a selection button SB2 are displayed on an all-white image. Therefore, the sixth projection image GP6 is an image in which the dialog box DB2 and the selection button SB2 are added to the fifth projection image GP5.

In the dialog box DB2, a message “Are the positions of the displayed feature points correct?” and the selection button SB2 are displayed. The selection button SB2 includes a “Yes” button SB2-1 and a “No” button SB2-2. The user can select the “Yes” button SB2-1 or the “No” button SB2-2 by operating the operation device 15. In other words, the dialog box DB2 presents, to the user, an inquiry as to whether the positions of the projected four feature points FP1-1 to FP1-4 coincide with the corresponding four corners CN1-1 to CN1-4.

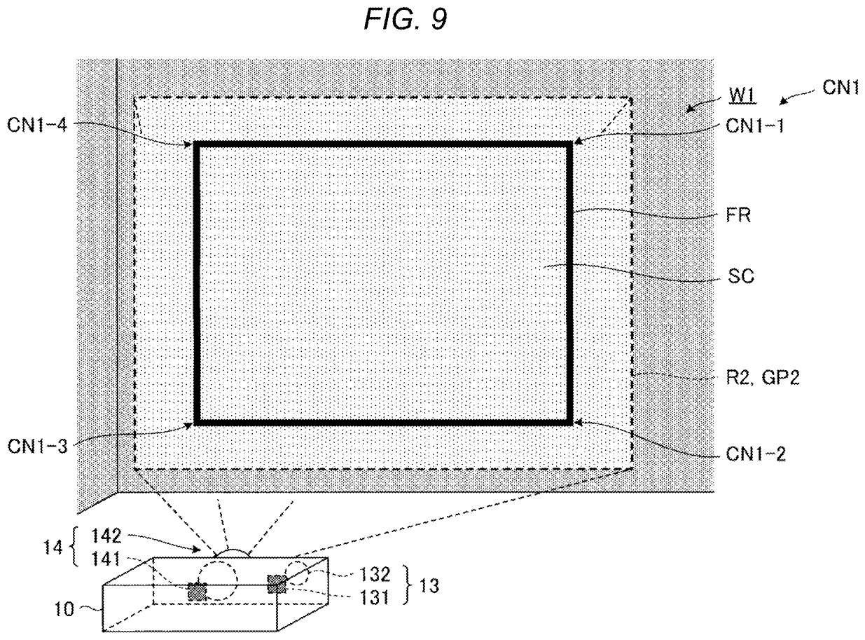

FIG. 9 is a schematic diagram showing how the second projection image GP2 is displayed. As shown in FIG. 9, the second projection image GP2 is an all-white image in which the luminance is lower than the luminance of the first projection image GP1. That is, the second projection image GP2 is an image that is different from the first projection image GP1. The second projection image GP2 is not limited to the all-white image in which the luminance is lower than the luminance of the first projection image GP1. The second projection image GP2 is not limited to an all-white image and may be an image of another color. The second projection image GP2 is not limited to a monochromatic image and may be an image containing a plurality of colors.

Referring again to FIG. 3, the third determiner 127 determines whether the user determines that the positions are “correct” in response to the message of the sixth projection image GP6. More specifically, when the user selects the “Yes” button SB2-1, the processing device 12 determines that the user determines that the positions are “correct” (YES). Meanwhile, when the user selects the “No” button SB2-2, the processing device 12 determines that the user does not determine that the positions are “correct” (NO).

The image pickup element 131 is an image sensor such as a CCD or a CMOS. CCD is an abbreviation for charge-coupled device, and CMOS is an abbreviation for complementary metal-oxide semiconductor.

Under the control of the image pickup controller 122, the image pickup device 13 picks up an image over a range including an area on the projection surface in which the projection image is displayed. The image pickup device 13 outputs, to the processing device 12, the picked-up image information 108 representing the result of picking up an image over the range including the area on the projection surface in which the projection image is displayed. In other words, the image pickup device 13 outputs the picked-up image represented by the picked-up image information 108 to the processing device 12.

The light modulator 141 includes, for example, one or a plurality of liquid crystal panels. The light modulator 141 may include a DMD instead of a liquid crystal panel. The light modulator 141 modulates light emitted from a light source into projection light for displaying a projection image on the projection surface, based on a signal input from the processing device 12. Examples of the light source include a halogen lamp, a xenon lamp, an ultra-high-pressure mercury lamp, an LED, and a laser light source. LED is an abbreviation for light-emitting diode, and DMD is an abbreviation for digital mirror device.

The projection device 14 projects projection light for displaying a projection image on the projection surface under the control of the projection controller 121. In other words, the projection device 14 projects an image input from the processing device 12 onto the projection surface.

The operation device 15 accepts an input operation on the projector 10 from the user of the projector 10. The operation device 15 includes, for example, a touch panel or an operation button or the like provided on the housing of the projector 10. When the operation device 15 includes the touch panel, the operation device 15 outputs data representing a detected touched position to the processing device 12. When the operation device 15 includes the operation button, the operation device 15 outputs data for identifying a pressed button to the processing device 12. The operation device 15 may include a receiving device for receiving an operation signal output from a remote controller, based on an operation by the user. When the operation device 15 includes the receiving device, the operation device 15 outputs, to the processing device 12, data represented by the operation signal received from the remote controller. Thus, the content of the input operation on the projector 10 is transmitted to the processing device 12.

The communication device 16 is hardware serving as a transmission and receiving device for communicating with other devices. The communication device 16 is also called, for example, network device, network controller, network card, communication module, or the like. The communication device 16 may include a connector for wired connection and an interface circuit corresponding to the connector. The communication device 16 may include a wireless communication interface. Examples of the connector for wired connection and the interface circuit include products conforming to HDMI (high-definition multimedia interface (registered trademark), DisplayPort (registered trademark), wired LAN, IEEE1394, USB, or the like. Examples of the wireless communication interface include products conforming to wireless LAN and Bluetooth (registered trademark) or the like.

### 1.4. Configuration of Server

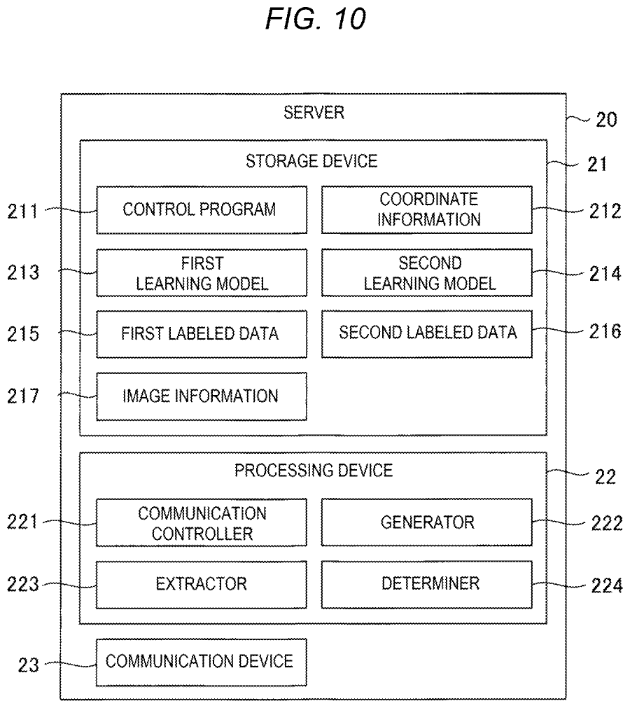

FIG. 10 is a block diagram showing the configuration of the server 20. The server 20 includes a storage device 21 that stores various information, a processing device 22 that controls the operation of the server 20, and a communication device 23 that communicates with other devices. The elements provided in the server 20 are connected to one another by a single bus or a plurality of buses for communicating information. The server 20 is an example of an external device.

The processing device 22 has functions as a communication controller 221, a generator 222, an extractor 223, and a determiner 224.

The storage device 21 includes a volatile memory such as a RAM and a nonvolatile memory such as a ROM. The storage device 21 stores a control program 211, coordinate information 212, a first learning model 213, a second learning model 214, first labeled data 215, second labeled data 216, image information 217, and the like. The volatile memory of the storage device 21 is used by the processing device 22 as a work area of the processing device 22. The control program 211 is a program that controls the entirety of the server 20.

A part or the entirety of the storage device 21 may be provided in an external storage device, an external server, or the like. A part or all of the various information stored in the storage device 21 may be stored in the storage device 21 in advance or may be acquired from an external storage device, an external server, or the like.

The processing device 22 includes one or a plurality of CPUs. However, the processing device 12 may include a programmable logic device such as an FPGA, or an ASIC, instead of the CPU or in addition to the CPU.

The processing device 22 reads the control program 211 from the storage device 21. The processing device 22 executes the read control program 211 and thus functions as the communication controller 221, the generator 222, the extractor 223, and the determiner 224 illustrated in FIG. 10.

The communication controller 221 receives various information including a picked-up image output from the projector 10, via the communication device 23. The communication controller 221 transmits various information including coordinate information and image information to the projector 10 via the communication device 23.

The generator 222 generates the first learning model 213 and the second learning model 214. More specifically, the generator 222 causes a neural network model to perform machine learning using a plurality of data sets contained in first labeled data 215 and thus generates the first learning model 213. The generator 222 also causes a neural network model to perform machine learning using a plurality of data sets contained in second labeled data 216 and thus generates the second learning model 214. The first learning model 213 is an example of a trained model.

More specifically, the labeled data of the first learning model 213 is configured with a plurality of data sets, each of which is formed of input data including a picked-up image formed by picking up an image of an area including a projection image projected on a projection target in the preparation for the installation of the projector and the projection target, output data including coordinates of four feature points corresponding to the four corners of the projection target extracted from the picked-up image, and a determination label indicating whether the positions of the four feature points coincide with the positions of the corresponding four corners. The configuration of the labeled data is not limited thereto. Specifically, the input data may not include the projection image.

The determination label indicating whether the positions of the four feature points coincide with the positions of the corresponding four corners is determined by the user. More specifically, the user views the projection image including the extracted feature points and determines whether the positions of the four feature points coincide with the positions of the corresponding four corners.

In the present embodiment, a convolutional neural network (CNN) is used as the first learning model 213.

The labeled data of the second learning model 214 is configured with a plurality of data sets, each of which is formed of input data including a picked-up image formed by picking up an image of an area including a projection image projected on a projection target in the preparation for the installation of the projector and the projection target, output data including information on a projection image projected to extract four feature points again when the positions of the four feature points corresponding one-to-one to the four corners of the projection target extracted from the picked-up image do not coincide with the positions of the corresponding four corners, and a determination label indicating whether the positions of the four feature points extracted using the projection image projected to extract the four feature points again coincide with the positions of the corresponding four corners. The configuration of the labeled data is not limited thereto. Specifically, the input data may not include the projection image.

The determination label indicating whether the positions of the four feature points coincide with the positions of the corresponding four corners is determined by the user. More specifically, the user views the projection image including the extracted feature points and determines whether the positions of the four feature points coincide with the positions of the corresponding four corners.

In the present embodiment, a CNN is used as the second learning model 214.

The extractor 223 inputs the first picked-up image GS1 to the first learning model 213. The extractor 223 acquires the coordinates of the four feature points FP1-1 to FP1-4 corresponding to the four corners CN1-1 to CN1-4 output from the first learning model 213. The extractor 223 causes the storage device 21 to store the coordinate information 212 representing the acquired coordinates of the four feature points FP1-1 to FP1-4. The coordinate information 212 is an example of first output data. The first picked-up image GS1 input to the first learning model 213 is an example of first input data.

The determiner 224 determines the second projection image GP2 that is to be projected by the projection device 14. More specifically, the determiner 224 inputs the first picked-up image GS1 to the second learning model 214 and thus determines the second projection image GP2, based on the image information 217 related to the projection image output from the second learning model 214. In addition, when the image information 217 related to the projection image is output from the second learning model 214, the determiner 224 causes the storage device 21 to store the image information 217 related to the projection image. The image information 217 may be code information representing the type of the image or may be information including data of the image.

The communication device 23 is hardware serving as a transmission and receiving device for communicating with other devices. The communication device 23 is also called, for example, network device, network controller, network card, communication module, or the like. The communication device 23 may include a connector for wired connection and an interface circuit corresponding to the connector. The communication device 23 may include a wireless communication interface. Examples of the connector for wired connection and the interface circuit include products conforming to wired LAN, IEEE1394, USB, and the like. Examples of the wireless communication interface include products conforming to wireless LAN and Bluetooth (registered trademark) or the like.

### 1.5. Specific Operation in Image Display System 1

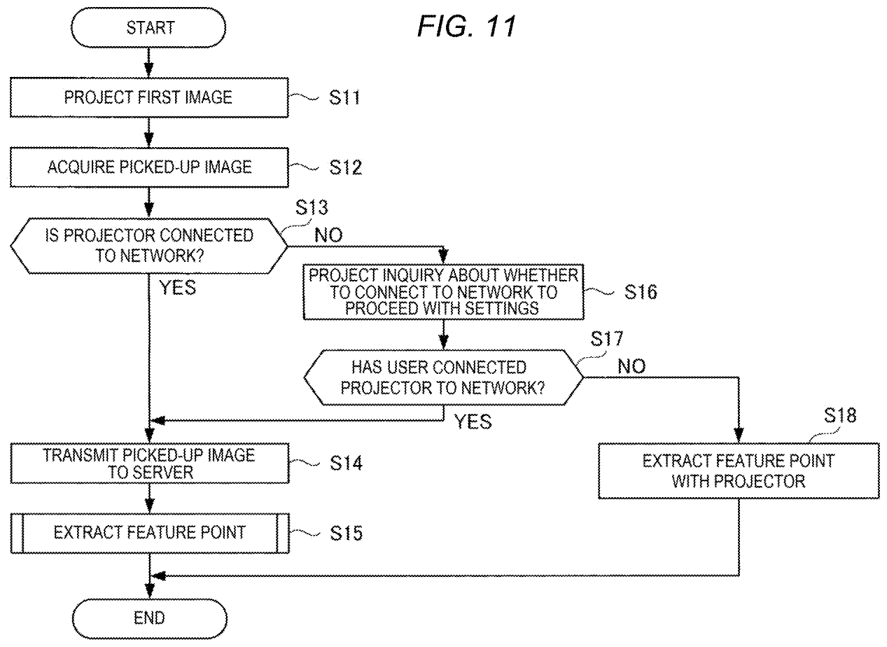

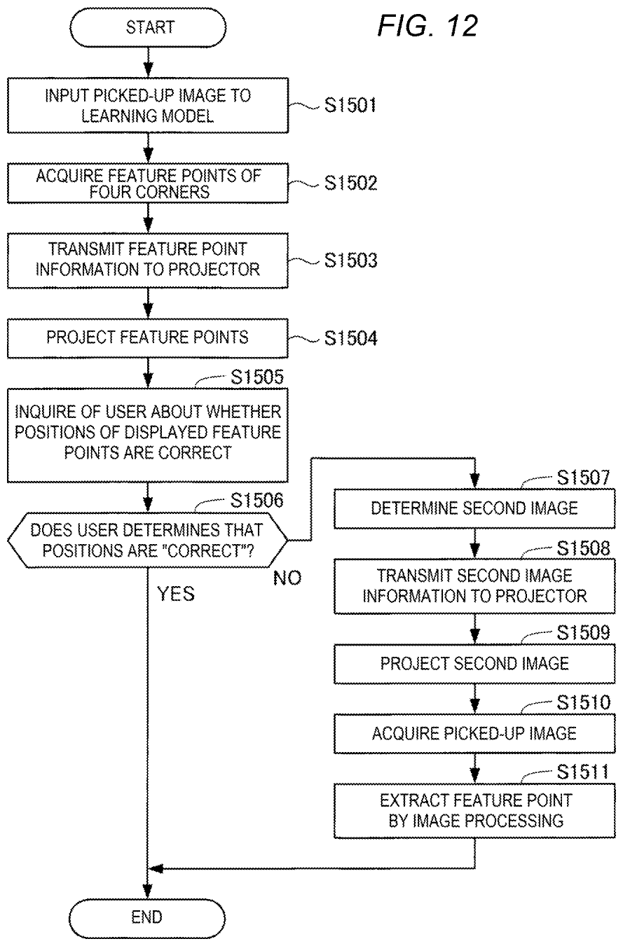

Subsequently, a specific operation in the image display system 1 will be described with reference to FIGS. 11 and 12.

### 1.5.1. Operation of Image Display System

FIG. 11 is a flowchart showing operations of the processing device 12 shown in FIG. 3 and the processing device 22 shown in FIG. 10. Hereinafter, operations of the processing device 12 and the processing device 22 will be described with reference to FIG. 11. The routine in FIG. 11 is started, for example, when the user operates the operation device 15 to call the function of preparing for the installation of the projector 10 for the projection image.

In step S11, the processing device 12 functions as the projection controller 121 and thus projects the first projection image GP1 onto the screen SC.

The first projection image GP1 is an all-white image.

In step S12, the processing device 12 functions as the image pickup controller 122 and thus acquires the first picked-up image GS1 including the first area R1, using the image pickup device 13. The processing device 12 also stores first picked-up image information 109 representing the acquired first picked-up image GS1 in the storage device 11.

In step S13, the processing device 12 functions as the first determiner 123 and thus determines whether the projector 10 is connected to the network NET.

When the projector 10 is connected to the network NET, that is, when the determination result in step S13 is YES, the processing device 12 in step S14 functions as the communication controller 124 and thus transmits the first picked-up image GS1 to the server 20 via the communication device 16.

In step S15, the processing device 12 and the processing device 22 extract feature points and temporarily end this routine. Details of the processing in step S15 will be described later.

Meanwhile, when the projector 10 is not connected to the network NET, that is, when the determination result in the step S13 is NO, the processing device 12 in step S16 functions as the projection controller 121 and thus projects, onto the screen SC, the third projection image GP3 including an inquiry as to whether to connect the projector 10 to the network NET to proceed with “setting for installation”. More specifically, in this case, the processing device 12 projects, onto the screen SC, the dialog box DB1 including the message “When connected to the network, the installation can be prepared earlier. Would you like to connect to the network?” and the selection buttons SB1 for “Yes” and “No”.

In step S17, the processing device 12 functions as the second determiner 125 and thus determines whether the user has connected the projector 10 to the network NET.

When it is determined that the user has connected the projector 10 to the network NET, that is, when the determination result in step S17 is YES, the processing device 12 in step S14 functions as the communication controller 124 and thus transmits the picked-up image to the server 20. Specifically, in step S14, the processing device 12 functions as the communication controller 124 and thus transmits the first picked-up image GS1 to the server 20.

Meanwhile, when it is determined that the user has not connected the projector 10 to the network NET, that is, when the determination result in step S17 is NO, the processing device 12 in step S18 functions as the extractor 126 and thus extracts the feature points FP2-1 to FP2-4 corresponding one-to-one to the four corners CN1-1 to CN1-4 of the screen SC, and temporarily ends this routine.

### 1.5.2. Operation of Image Display System

FIG. 12 is a flowchart showing an example of the operation of the subroutine shown in FIG. 11.

Hereinafter, the operation of the subroutine of step S15 will be described with reference to FIG. 12.

In step S1501, the processing device 22 functions as the extractor 223 and thus inputs the first picked-up image GS1 to the first learning model 213.

In step S1502, the processing device 22 functions as the extractor 223 and thus acquires the coordinates of the four feature points FP1-1 to FP1-4 corresponding to the four corners CN1-1 to CN1-4, which are output from the first learning model 213. The processing device 22 causes the storage device 21 to store the coordinate information 212 representing the acquired coordinates of the four feature points FP1-1 to FP1-4.

In step S1503, the processing device 22 functions as the communication controller 221 and thus transmits feature point information related to the acquired four feature points to the projector 10.

In step S1504, the processing device 12 functions as the projection controller 121 and thus projects the fifth projection image GP5 including the feature points FP1-1 to FP1-4 onto the screen SC.

In step S1505, the processing device 12 functions as the projection controller 121 and thus inquires of the user about whether the positions of the feature points FP1-1 to FP1-4 displayed on the screen SC are correct. More specifically, the processing device 12 projects the sixth projection image GP6 including the feature points, the message “Are the positions of the displayed feature points correct?”, and the selection buttons SB2 for “Yes” and “No”, onto the screen SC. The “the positions of the feature points are correct” means that the feature points FP1-1 to FP1-4 coincide with the four corners CN1-1 to CN1-4 of the frame FR of the screen SC, respectively.

In step S1506, the processing device 12 functions as the third determiner 127 and thus determines whether the user determines that the positions are “correct”.

When it is determined that the user determines that the positions are “correct”, that is, when the determination result in step S1506 is YES, the processing device 12 temporarily ends this routine. That is, the positions of the extracted feature points FP1-1 to FP1-4 are determined as the positions of the four corners CN1-1 to CN1-4 of the frame FR of the screen SC, respectively.

Meanwhile, when it is determined that the user does not determine that the positions are “correct”, that is, when the determination result in step S1506 is NO, the processing device 22 in step S1507 functions as the determiner 224 and thus determines the second projection image GP2 that is to be projected by the projection device 14. More specifically, as the first picked-up image GS1 is input to the second learning model 214, the second projection image GP2 is determined, based on second image information representing the “type of the image” output from the second learning model 214.

In step S1508, the processing device 22 functions as the communication controller 221 and thus transmits the determined second image information to the projector 10 via the communication device 23.

In step S1509, the processing device 12 functions as the projection controller 121 and thus projects the second projection image GP2 based on the second image information onto the screen SC.

In step S1510, the processing device 12 functions as the image pickup controller 122 and thus acquires the second picked-up image GS2. More specifically, the processing device 12 acquires the second picked-up image GS2 formed by the image pickup device 13 picking up an image over the range of a second area R2 including the screen SC on which the second projection image GP2 is projected.

In step S1511, the processing device 12 functions as the extractor 126 and thus extracts the four groups of feature points FP2-1 to FP2-4 corresponding to the four corners CN1-1 to CN1-4 by image processing, and temporarily ends this routine.

### 1.6. Effects Achieved by First Embodiment

As described above, the feature point extraction method according to the first embodiment includes inputting the first picked-up image GS1 to the first learning model 213, and acquiring the coordinate information 212 representing the coordinates of the four feature points FP1-1 to FP1-4 corresponding to the four corners CN1-1 to CN1-4 output from the first learning model 213. When input data including a projection target on which an image from the projection device is projected and a picked-up image formed by picking up an image of an area including the four corners of the projection target is input, the first learning model 213 outputs output data representing the four feature points FP1-1 to FP1-4 corresponding one-to-one to the four corners in the picked-up image. The first picked-up image GS1 is an image formed by picking up an image of the first area R1 including the screen SC and the four corners CN1-1 to CN1-4 of the screen SC.

According to this aspect, when the input data including the first picked-up image GS1 formed by picking up an image of the area including the screen SC on which the image from the projection device 14 is projected and the corner CN1 of the screen SC is input, the first learning model 213 outputs the output data representing the one feature point FP1 corresponding to the one corner CN1 in the first picked-up image GS1. Therefore, the time and effort for the user to consider in order to select an appropriate feature point from among some feature point candidates corresponding to the one corner CN1 of the screen SC is reduced, and the troublesomeness felt by the user is reduced. Therefore, user convenience is improved. Also, according to this aspect, since the feature points FP1-1 to FP1-4 are extracted at the four corners CN1-1 to CN1-4, respectively, the accuracy of the geometric correction using the extracted feature points is improved.

In the feature point extraction method according to the first embodiment, the first picked-up image GS1 is picked up by the image pickup device 13, the first learning model 213 is provided in the server 20, the first input data is transmitted from the image pickup device 13 to the server 20, and the coordinate information 212 is transmitted from the server 20 to the projection device 14.

According to the aspect, since the arithmetic processing for extracting the feature point FP1 is performed in the external server 20 instead of being performed by the processing device 12 of the projector 10, the processing load of the processing device 12 of the projector 10 is reduced. Also, when the arithmetic processing for extracting the feature point FP1 needs to be updated, the control program 100 of the processing device 12 of the projector 10 need not be updated and therefore the burden on the user is reduced.

The feature point extraction method according to the first embodiment further includes projecting the acquired four feature points FP1-1 to FP1-4 onto the screen SC, projecting the second projection image GP2 different from the first projection image GP1 projected when the first picked-up image GS1 is picked up when the user's response to the inquiry as to whether the positions of the projected four feature points FP1-1 to FP1-4 coincide with the corresponding four corners CN1-1 to CN1-4 is NO, performing the first image processing on the second picked-up image GS2, and acquiring the coordinate information 111 representing the four groups of feature points FP2-1 to FP2-4 corresponding one-to-one to the four corners extracted by the first image processing. The second picked-up image GS2 is an image formed by picking up an image of the second area R2 including the screen SC, the four corners CN-1 to CN1-4, and the second projection image GP2 projected on the screen SC.

When the extracted feature point FP1 is not accepted by the user, the feature point may be extracted again. According to this aspect, the projection image projected when the feature point is extracted again is changed from the first projection image GP1 to the second projection image GP2, and the image processing is used for extracting the feature point instead of the first learning model 213. Therefore, the position of the feature point that is extracted again is expected to change from the original position of the feature point.

### 2. Modification Examples

The present disclosure is not limited to the above embodiment, and various modification examples can be adopted within the scope of the present disclosure. Specific examples of modification will be given below. Two or more examples freely selected from the examples given below can be combined as appropriate to an extent that no contradiction occurs. In the modification examples given below, the reference numerals and signs used in the above description are used for elements having actions and functions equivalent to those in the above embodiment, and a detailed description of the elements is omitted as appropriate.

### 2.1. Modification Example 1

In the first embodiment, the first projection image GP1 is an all-white image. In this case, the determiner 224 may determine the second projection image, based on the luminance distribution of the first picked-up image GS1. The luminance distribution indicates the degree of reflection of light by the screen SC in the first picked-up image GS1. The first picked-up image GS1 further includes the first projection image GP1. The luminance distribution in this case may be represented using a Y value of XYZ values or may be represented using RGB values.

For example, in the preparation stage for the installation of the projector, when it is known that a change in the degree of reflection of light due to the reflectance and the shape of the projection target affects the accuracy of extracting the feature point, based on the accumulation of data up to this point, and it is known that changing the projection image improves the accuracy of extracting the feature point, it is conceivable to prepare a plurality of projection images as candidates.

In the first embodiment, the first picked-up image GS1 is input to the second learning model 214 and the second projection image GP2 is thus determined, but in the learning model according to Modification Example 1, information of the average luminance of the first projection image GP1 is input in addition to the first picked-up image GS1, and the second projection image is thus determined. The average luminance of the first projection image GP1 is found as the average luminance in the range in which the first area R1 in the first picked-up image GS1 is picked up.

Therefore, the input data in the labeled data of the learning model according to Modification Example 1 includes the picked-up image formed by picking up an image of the area including the projection image projected on the projection target in the preparation for the installation of the projector and the projection target, and the average luminance of the projection image.

According to this aspect, as the projection image is changed, the accuracy of extracting the feature point is expected to be improved.

### 2.2. Modification Example 2

In Modification Example 1, the first picked-up image GS1 and the average luminance of the first projection image GP1 are used as the input data of the learning model, but in Modification Example 2, in addition to the first picked-up image GS1 and the average luminance of the first projection image GP1, set values of the gain and the exposure of the image pickup device 13 when the first picked-up image GS1 is picked up may be used as the input data of the learning model.

According to this aspect, since the learning model is trained using the image pickup condition of the image pickup device 13, further improvement in the accuracy of extracting the feature point is expected.

### 2.3. Modification Example 3

In the first embodiment, whether the positions of the four feature points coincide with the positions of the corresponding four corners is determined, but whether each of the positions of the four feature points coincides with the position of the corresponding corner may be determined individually.

### 2.4. Modification Example 4

In the first embodiment, whether the positions of the four feature points coincide with the positions of the corresponding four corners is determined, and when the user determines that the positions do not coincide with each other, the feature points are extracted again, but the user may be able to operate the operation device 15 to correct the position of the feature point determined as not coinciding with the position of the corner.

### 2.5. Modification Example 5

In the first embodiment, the user determines whether the positions of the four feature points coincide with the positions of the corresponding four corners, but may give multiple-grade evaluation values. For example, a configuration in which five-grade evaluation values are given is conceivable. In the configuration in which the multiple-grade evaluation values are given, a weighted average of the coordinates of the previously extracted feature points and the coordinates of the re-extracted feature points is calculated with the weighting distribution changed according to the evaluation values.

### 2.6. Modification Example 6

In the first learning model 213, one data set is formed of input data including a picked-up image formed by picking up an image of an area including a projection image projected on a projection target in the installation preparation of the projector and the projection target, and output data including coordinates of four feature points corresponding one-to-one to the four corners of the projection target, extracted from the picked-up image, and from among a plurality of data sets, only a data set in which the user determines that the positions of the four feature points coincide with the positions of the corresponding four corners may be used as the labeled data. According to this aspect, the coordinates of the extracted feature point are used as a ground truth label.

### 2-7. Modification Example 7

In the first embodiment, the first learning model 213 and the second learning model 214 are stored in the storage device 21 of the server 20 and the processing load of the processing device 12 of the projector 10 is thus reduced, but the present disclosure is not limited to this aspect. Depending on the capability of the processing device of the projector 10, the first learning model and/or the second learning model may be stored in the storage device 11 of the projector 10 and arithmetically processed by the processing device 12.

### 2-8. Modification Example 8

In the first embodiment, when the user determines that the position of the feature point FP1 extracted by the extractor 223 of the server 20 is not correct, the projection image is changed from the first projection image GP1 to the second projection image GP2, and the feature point is extracted via image processing by the extractor 126 of the projector 10. However, the present disclosure is not limited to this aspect. In Modification Example 8, when the user determines that the position of the feature point FP1 extracted by the extractor 223 of the server 20 is not correct, the projection image may be changed from the first projection image GP1 to the second projection image GP2, and the feature point may be extracted again by the extractor 223 of the server 20.

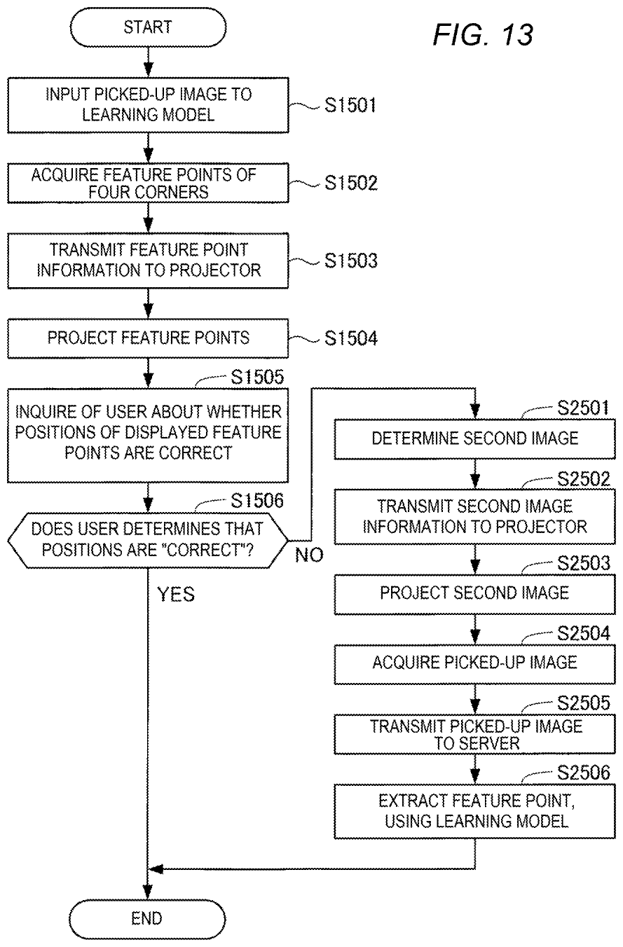

FIG. 13 is a flowchart illustrating an example of the operation according to Modification Example 8. Hereinafter, the operation according to Modification Example 8 will be described with reference to FIG. 13. FIG. 13 corresponds to the flowchart of FIG. 12, and the same steps as those shown in FIG. 12 are denoted by the same reference numerals.

In step S1501, the processing device 22 functions as the extractor 223 and thus inputs the first picked-up image GS1 to the first learning model 213.

In step S1502, the processing device 22 functions as the extractor 223 and thus acquires the coordinates of the four feature points FP1-1 to FP1-4 corresponding to the four corners CN1-1 to CN1-4, which are output from the first learning model 213. The processing device 22 causes the storage device 21 to store the coordinate information 212 representing the acquired coordinates of the four feature points FP1-1 to FP1-4.

In step S1503, the processing device 22 functions as the communication controller 221 and thus transmits feature point information related to the acquired four feature points to the projector 10.

In step S1504, the processing device 12 functions as the projection controller 121 and thus projects the fifth projection image GP5 including the feature points FP1-1 to FP1-4 onto the screen SC.

In step S1505, the processing device 12 functions as the projection controller 121 and thus inquires of the user about whether the positions of the feature points FP1-1 to FP1-4 displayed on the screen SC are correct. More specifically, the processing device 12 projects the sixth projection image GP6 including the feature points, the message “Are the positions of the displayed feature points correct?”, and the selection buttons SB2 for “Yes” and “No”, onto the screen SC. The “the positions of the feature points are correct” means that the feature points FP1-1 to FP1-4 coincide with the four corners CN1-1 to CN1-4 of the frame FR of the screen SC, respectively.

In step S1506, the processing device 12 functions as the third determiner 127 and thus determines whether the user determines that the positions are “correct”.

When it is determined that the user determines that the positions are “correct”, that is, when the determination result in step S1506 is YES, the processing device 12 temporarily ends this routine. That is, the positions of the extracted feature points FP1-1 to FP1-4 are determined as the positions of the four corners CN1-1 to CN1-4 of the frame FR of the screen SC, respectively.

Meanwhile, when it is determined that the user does not determine that the positions are “correct”, that is, when the determination result in step S1506 is NO, the processing device 22 in step S2501 functions as the determiner 224 and thus determines the second projection image GP2 that is to be projected by the projection device 14. More specifically, as the first picked-up image GS1 is input to the second learning model 214, the second projection image GP2 is determined, based on second image information representing the “type of the image” output from the second learning model 214.

In step S2502, the processing device 22 functions as the communication controller 221 and thus transmits the determined second image information to the projector 10 via the communication device 23.

In step S2503, the processing device 12 functions as the projection controller 121 and thus projects the second projection image GP2 based on the second image information onto the screen SC.

In step S2504, the processing device 12 functions as the image pickup controller 122 and thus acquires the second picked-up image GS2. More specifically, the processing device 12 acquires the second picked-up image GS2 formed by the image pickup device 13 picking up an image over the range of a second area R2 including the screen SC on which the second projection image GP2 is projected.

In step S2505, the processing device 12 functions as the communication controller 124 and thus transmits the second picked-up image GS2 to the server 20 via the communication device 16.

In step S2506, the processing device 22 functions as the extractor 223 and thus acquires the coordinates of the four feature points FP2-1 to FP2-4 corresponding to the four corners CN1-1 to CN1-4, which are output from the first learning model 213, and temporarily ends this routine. The processing device 22 causes the storage device 21 to store the coordinate information 212 representing the acquired coordinates of the four feature points FP2-1 to FP2-4.

### 2.9. Modification Example 9

In the first embodiment, the image display system 1 using one projector is described as an example, but the present disclosure is not limited to this aspect and may be applied to a multi-projection system which realizes a horizontally long or stacked large screen, using a plurality of projectors.

### 2.10. Modification Example 10

In the first embodiment, the projector 10 projects the projection light in the first area R1 including the screen SC as the projection surface in the first period, but the present disclosure is not limited to this aspect. For example, instead of projecting the projection light in the first area R1 including the screen SC as the projection surface, the room in which the screen SC as the projection surface is installed may be in a bright state. That is, when extracting the feature points corresponding to the four corners CN1-1 to CN1-4 of the frame FR of the screen SC, the projection light may not be projected in the first area R1 including the screen SC as the projection surface.

### 2.11. Modification Example 11

In the first embodiment, the determiner 224 inputs the first picked-up image GS1 to the second learning model 214 and thus determines the second projection image GP2 that is to be projected by the projection device 14, but the present disclosure is not limited to this aspect. For example, the determiner 224 may determine the second projection image GP2 that is to be projected by the projection device 14, based on the image information 217 related to the projection image set in advance, without using the second learning model 214.

In the feature point extraction method according to Modification Example 11, the second projection image GP2 is determined in advance as an image to be projected after the first projection image GP1.

For example, when there are a plurality of projection images suitable for the extraction of the feature point based on the accumulation of data up to this point, it is conceivable to prepare the plurality of projection images as candidates. According to this aspect, as the projection image is changed, the accuracy of extracting the feature point is expected to be improved.

### 3. Appendices

The present disclosure will be summarized below as appendices.

### 3.1. Appendix 1

According to Appendix 1, a feature point extraction method includes: inputting first input data including a first picked-up image formed by picking up an image of a first area including a first projection target and at least one first corner of the first projection target, to a trained model that, when input data including a picked-up image formed by picking up an image of an area including a projection target onto which an image from a projection device is projected and at least one corner of the projection target is input thereto, outputs output data representing at least one feature point corresponding one-to-one to the at least one corner in the picked-up image; and acquiring first output data representing at least one first feature point corresponding one-to-one to the at least one first corner output from the trained model.

In the feature point extraction method according to Appendix 1, when input data including a picked-up image formed by picking up an image of an area including a screen onto which an image from the projection device is projected and a corner of the screen is input, the trained model outputs output data representing one feature point corresponding to one corner in the picked-up image. Therefore, the time and effort for the user to consider in order to select an appropriate feature point from among some feature point candidates corresponding to the one corner of the screen is reduced, and the troublesomeness felt by the user is reduced. Therefore, user convenience is improved.

### 3.2. Appendix 2

According to Appendix 2, in the feature point extraction method according to Appendix 1, the projection target includes four first corners, the trained model outputs, when input data including a picked-up image formed by picking up an image of an area including the projection target and the four corners of the projection target is input thereto, output data representing four feature points corresponding one-to-one to the four corners in the picked-up image, the first picked-up image is an image formed by picking up an image of a first area including the first projection target and the four first corners of the first projection target, and the first output data represents four first feature points corresponding one-to-one to the four first corners output from the trained model.

In the feature point extraction method according to Appendix 2, the feature point is extracted at each of the four corners and therefore the accuracy of geometric correction using the extracted feature point is improved.

### 3.3. Appendix 3

According to Appendix 3, in the feature point extraction method according to Appendix 1 or 2, the first picked-up image is picked up by a first image pickup device, the trained model is provided in an external device, the first input data is transmitted from the first image pickup device to the external device, and the first output data is transmitted from the external device to the projection device.

In the feature point extraction method of Appendix 3, the arithmetic processing for extracting the feature point is performed in the external device instead of the processing device of the projection device, and therefore the processing load of the processing device of the projection device is reduced. Also, when the arithmetic processing for extracting the feature point needs to be updated, the control program of the processing device of the projection device need not be updated and therefore the burden on the user is reduced.

### 3.4. Appendix 4

According to Appendix 4, the feature point extraction method according to any one of Appendices 1 to 3 further includes: projecting the at least one acquired first feature point onto the first projection target; projecting a second projection image that is different from a first projection image projected when the first picked-up image is picked up when a user's response to an inquiry as to whether a position of the at least one projected first feature point coincides with the at least one first corner is negative; inputting, to the trained model, a second picked-up image formed by picking up an image of a second area including the first projection target, the at least one first corner, and the second projection image projected on the first projection target; and acquiring second output data representing at least one second feature point corresponding one-to-one to the at least one first corner output from the trained model.

In the feature point extraction method according to Appendix 4, when the extracted feature point is not accepted by the user, the feature point may be extracted again. According to this aspect, the projection image projected when extracting the feature point again is changed from the first projection image to the second projection image, and therefore the position of the feature point that is extracted again is expected to change from the original position of the feature point.

### 3.5. Appendix 5

According to Appendix 5, the feature point extraction method according to any one of Appendices 1 to 3 further includes: projecting the at least one acquired first feature point onto the first projection target; projecting a second projection image that is different from a first projection image projected when the first picked-up image is picked up when a user's response to an inquiry as to whether a position of the at least one projected first feature point coincides with the at least one first corner corresponding thereto is negative; performing first image processing on a second picked-up image formed by picking up an image of a second area including the first projection target, the at least one first corner, and the second projection image projected on the first projection target; and acquiring third output data representing at least one third feature point corresponding one-to-one to the at least one first corner detected by the first image processing.

When the extracted feature point is not accepted by the user, the feature point may be extracted again. In the feature point extraction method of Appendix 5, the projection image projected when extracting the feature point again is changed from the first projection image to the second projection image, and instead of the trained model, the image processing is used to extract the feature point. Therefore, the position of the feature point that is extracted again is expected to change from the original position of the feature point.

### 3.6. Appendix 6

According to Appendix 6, in the feature point extraction method according to Appendix 4, the second projection image is predetermined as an image to be projected after the first projection image.

For example, when there are a plurality of projection images suitable for the extraction of the feature point based on the accumulation of data up to this point, it is conceivable to prepare the plurality of projection images as candidates. In the feature point extraction method according to Appendix 6, as the projection image is changed, the accuracy of extracting the feature point is expected to improved.

### 3.7. Appendix 7

According to Appendix 7, the feature point extraction method according to Appendix 4 further includes determining the second projection image, based on a luminance distribution of the first picked-up image, when the first projection image is a white image, and the luminance distribution indicates a degree of reflection of light by the first projection target in the first picked-up image, and the first picked-up image further includes the first projection image.

For example, when it is known that a change in the degree of reflection of light due to the reflectance and the shape of the projection target affects the accuracy of extracting the feature point, based on the accumulation of data up to this point, and it is known that changing the projection image improves the accuracy of extracting the feature point, it is conceivable to prepare a plurality of projection images as candidates. In the feature point extraction method according to Appendix 7, as the projection image is changed, the accuracy of extracting the feature point is expected to improved.

### 3.8. Appendix 8

According to Appendix 8, in the feature point extraction method according to Appendix 5, the second projection image is predetermined as an image to be projected after the first projection image.

For example, when there are a plurality of projection images suitable for the extraction of the feature point based on the accumulation of data up to this point, it is conceivable to prepare the plurality of projection images as candidates. In the feature point extraction method according to Appendix 8, as the projection image is changed, the accuracy of extracting the feature point is expected to improved.

### 3.9. Appendix 9

According to Appendix 9, the feature point extraction method according to Appendix 5 further includes determining the second projection image, based on a luminance distribution of the first picked-up image, when the first projection image is a white image, and the luminance distribution indicates a degree of reflection of light by the first projection target in the first picked-up image, and the first picked-up image further includes the first projection image.

For example, when it is known that a change in the degree of reflection of light due to the reflectance and the shape of the projection target affects the accuracy of extracting the feature point, based on the accumulation of data up to this point, and it is known that changing the projection image improves the accuracy of extracting the feature point, it is conceivable to prepare a plurality of projection images as candidates. In the feature point extraction method according to Appendix 9, as the projection image is changed, the accuracy of extracting the feature point is expected to improved.

### 3.10. Appendix 10

According to Appendix 10, the feature point extraction method according to any one of Appendices 1 to 9 further includes: projecting the at least one acquired first feature point onto the first projection target; acquiring a user's response to an inquiry as to whether the at least one projected first feature point coincides with the at least one first corner; and additionally training the trained model, using the first picked-up image, the first output data, and the acquired response as training data.

In the feature point extraction method according to Appendix 10, as a set of the first picked-up image, the first output data, and the response of the user is added to the training data, the accuracy of the trained model can be improved.

### 3.11. Appendix 11

According to Appendix 11, a feature point extraction system includes: an external device having a trained model that, when input data including a picked-up image formed by an image pickup device picking up an image of an area including a projection target onto which an image from a projection device is projected and at least one corner of the projection target is input thereto, outputs output data representing at least one feature point corresponding to the at least one corner in the picked-up image; a first projection device that projects a first projection image onto a first projection target; and a first image pickup device that picks up an image of a first area including the first projection image, the first projection target, and at least one first corner of the first projection target, and the first image pickup device transmits first input data including a first picked-up image formed by picking up an image of the first area, to the external device, and the external device inputs the first input data to the trained model, acquires first output data representing at least one first feature point corresponding to the at least one first corner output from the trained model, and transmits the first output data to the first projection device.

In the feature point extraction system according to Appendix 11, when input data including a picked-up image formed by picking up an image of an area including a screen onto which an image from the projection device is projected and a corner of the screen is input, the trained model outputs output data representing one feature point corresponding to one corner in the picked-up image. Therefore, the time and effort for the user to consider in order to select an appropriate feature point from among some feature point candidates corresponding to the one corner of the screen is reduced, and the troublesomeness felt by the user is reduced. Therefore, user convenience is improved.

### 3.12. Appendix 12

According to Appendix 12, a Non-transitory computer-readable storage medium storing a program is provided, and the program causes a computer to execute: inputting first input data representing a first picked-up image including a first projection target and at least one first corner of the first projection target, to a trained model that, when input data including picked-up image information representing a picked-up image formed by picking up an image of an area including a projection target onto which an image from a projection device is projected and at least one corner of the projection target is input thereto, outputs output data representing at least one feature point corresponding to the at least one corner in the picked-up image; and acquiring first output data representing at least one first feature point corresponding to the at least one first corner output from the trained model.

With the program according to Appendix 12, when input data including a picked-up image formed by picking up an image of an area including a screen onto which an image from the projection device is projected and a corner of the screen is input, the trained model outputs output data representing one feature point corresponding to one corner in the picked-up image. Therefore, the time and effort for the user to consider in order to select an appropriate feature point from among some feature point candidates corresponding to the one corner of the screen is reduced, and the troublesomeness felt by the user is reduced. Therefore, user convenience is improved.

What is claimed is:

1. A feature point extraction method comprising:
inputting first input data including a first picked-up image formed by picking up an image of a first area including a first projection target and at least one first corner of the first projection target, to a trained model that, when input data including a picked-up image formed by picking up an image of an area including a projection target onto which an image from a projection device is projected and at least one corner of the projection target is input thereto, outputs output data representing at least one feature point corresponding one-to-one to the at least one corner in the picked-up image; and
acquiring first output data representing at least one first feature point corresponding one-to-one to the at least one first corner output from the trained model.

2. The feature point extraction method according to claim 1, wherein
the projection target includes four first corners,
the trained model outputs, when input data including a picked-up image formed by picking up an image of an area including the projection target and the four corners of the projection target is input thereto, output data representing four feature points corresponding one-to-one to the four corners in the picked-up image,
the first picked-up image is an image formed by picking up an image of a first area including the first projection target and the four first corners of the first projection target, and
the first output data represents four first feature points corresponding one-to-one to the four first corners output from the trained model.

3. The feature point extraction method according to claim 1, wherein
the first picked-up image is picked up by a first image pickup device,
the trained model is provided in an external device,
the first input data is transmitted from the first image pickup device to the external device, and
the first output data is transmitted from the external device to the projection device.

4. The feature point extraction method according to claim 1, further comprising:
projecting the at least one acquired first feature point onto the first projection target;
projecting a second projection image that is different from a first projection image projected when the first picked-up image is picked up when a user's response to an inquiry as to whether a position of the at least one projected first feature point coincides with the at least one first corner is negative;
inputting, to the trained model, a second picked-up image formed by picking up an image of a second area including the first projection target, the at least one first corner, and the second projection image projected on the first projection target; and
acquiring second output data representing at least one second feature point corresponding one-to-one to the at least one first corner output from the trained model.

5. The feature point extraction method according to claim 1, further comprising:
projecting the at least one acquired first feature point onto the first projection target;
projecting a second projection image that is different from a first projection image projected when the first picked-up image is picked up when a user's response to an inquiry as to whether a position of the at least one projected first feature point coincides with the at least one first corner corresponding thereto is negative;
performing first image processing on a second picked-up image formed by picking up an image of a second area including the first projection target, the at least one first corner, and the second projection image projected on the first projection target; and
acquiring third output data representing at least one third feature point corresponding one-to-one to the at least one first corner extracted by the first image processing.

6. The feature point extraction method according to claim 4, wherein
the second projection image is predetermined as an image to be projected after the first projection image.

7. The feature point extraction method according to claim 4, further comprising:
determining the second projection image, based on a luminance distribution of the first picked-up image when the first projection image is a white image, wherein
the luminance distribution indicates a degree of reflection of light by the first projection target in the first picked-up image, and
the first picked-up image further includes the first projection image.

8. The feature point extraction method according to claim 5, wherein
the second projection image is predetermined as an image to be projected after the first projection image.

9. The feature point extraction method according to claim 5, further comprising:
determining the second projection image, based on a luminance distribution of the first picked-up image, when the first projection image is a white image, wherein
the luminance distribution indicates a degree of reflection of light by the first projection target in the first picked-up image, and
the first picked-up image further includes the first projection image.

10. The feature point extraction method according to claim 1, further comprising:
projecting the at least one acquired first feature point onto the first projection target;
acquiring a user's response to an inquiry as to whether the at least one projected first feature point coincides with the at least one first corner; and
additionally training the trained model, using the first picked-up image, the first output data, and the acquired response as training data.

11. A feature point extraction system comprising:
an external device having a trained model that, when input data including a picked-up image formed by an image pickup device picking up an image of an area including a projection target onto which an image from a projection device is projected and at least one corner of the projection target is input thereto, outputs output data representing at least one feature point corresponding to the at least one corner in the picked-up image;
a first projection device that projects a first projection image onto a first projection target; and
a first image pickup device that picks up an image of a first area including the first projection image, the first projection target, and at least one first corner of the first projection target, wherein
the first image pickup device transmits first input data including a first picked-up image formed by picking up an image of the first area, to the external device, and
the external device
inputs the first input data to the trained model,
acquires first output data representing at least one first feature point corresponding to the at least one first corner output from the trained model, and
transmits the first output data to the first projection device.

12. A non-transitory computer-readable storage medium storing a program, the program causing a computer to execute:
inputting first input data representing a first picked-up image including a first projection target and at least one first corner of the first projection target, to a trained model that, when input data including picked-up image information representing a picked-up image formed by picking up an image of an area including a projection target onto which an image from a projection device is projected and at least one corner of the projection target is input thereto, outputs output data representing at least one feature point corresponding to the at least one corner in the picked-up image; and
acquiring first output data representing at least one first feature point corresponding to the at least one first corner output from the trained model.
